(19) United States
(12) Patent Application Publication
(10) Pub. No.: US 2017/0162230 A1
(43) Pub. Date: Jun. 8, 2017

(54) INTERACTIVE DIGITAL CAMERA FOR LIVE CROP EDITING AND RECORDING OF VIDEO STREAMS

(71) Applicant: Livestream LLC, Brooklyn, NY (US)

(72) Inventors: Sergii Maliuk, Brooklyn, NY (US); Philip Tomasz Worthington, New York, NY (US); Jimmy S. An, Hillsborough, NJ (US); Shi Gang Yuan, Brooklyn, NY (US); Jesse H. Hertzberg, New York, NY (US); Maxime G.G. Haot, New York, NY (US)

(21) Appl. No.: 15/366,872

(22) Filed: Dec. 1, 2016

Related U.S. Application Data
(60) Provisional application No. 62/263,333, filed on Dec. 4, 2015.

(51) Int. Cl. G11B 31/00; G11B 33/04; H04N 5/77; G11B 27/36; G11B 27/031; H04N 5/917; H04N 5/262; H04N 5/907; H04N 5/232

(52) U.S. Cl. CPC G11B 31/006; H04N 5/907; G11B 33/04; H04N 5/772; H04N 5/23293; G11B 27/031; H04N 5/917; H04N 5/2628; G11B 27/36

(57) ABSTRACT

A camera device comprising a body housing an image-capturing component and a first and second encoder component and a second encoder component coupled to the image capturing component is provided. The body has a first and a second surface opposite the first surface that is arranged to pitch the body at a determined angle upward with respect to a substantially planar surface upon which the camera device is placed. The image-capturing component is to capture an input stream in a viewing direction of the camera device. The first encoder component to generate a first video stream based on the input stream and the second encoder component to generate a second video stream based on the input stream. The first video stream depicts a full field of view (FOV) of an image associated with the input stream and the second video stream depicts a cropped view presentation of the full FOV.

### CROSS-REFERENCE TO RELATED APPLICATIONS

This application claims the benefit of U.S. Provisional Application No. 62/263,333 filed Dec. 4, 2015, the disclosure of which is incorporated herein by this reference in its entirety.

### TECHNICAL FIELD

Embodiments of the current disclosure relate generally to live video-editing and publishing, more specifically, to an interactive digital camera for live crop editing and recording of video streams.

### BACKGROUND

Many services provide live editing of video feeds from multiple camera angles. For example, some services may edit a live broadcast shown to viewers by changing the broadcast from one camera perspective to another camera perspective. In many situations this is accomplished, by swapping between video feeds from the multiple cameras filming at some event or mixing the video feeds together. Traditionally, the services may use specialized and expensive video editing equipment that is in communication with the multiple cameras positioned in different locations at the event.

### BRIEF DESCRIPTION OF THE DRAWINGS

The present disclosure is illustrated by way of example, and not by way of limitation, and will become apparent upon consideration of the following detailed description, taken in conjunction with the accompanying drawings, in which like reference characters refer to like parts throughout, and in which:

FIGS. 1A-1D are perspective views of an exemplary camera device accordance embodiments of the present disclosure.

FIG. 2 is a side view of the camera device in accordance with one embodiment of the present disclosure.

FIGS. 3A-3C are overhead views of an exemplary camera in accordance embodiments of the present disclosure.

FIGS. 4A-4D are perspective views of an exemplary base unit in accordance with embodiments of the present disclosure.

FIG. 5 is example view of the camera device of with the base unit in accordance with one embodiment of the present disclosure.

FIGS. 6A-6C are example side views of the camera device of with the base unit of in accordance with one embodiment of the present disclosure.

FIG. 7 illustrates a diagrammatic representation of the camera device in accordance with embodiments of the present disclosure.

FIGS. 8A-8E are perspective views of an accessory device for the camera device in accordance with embodiments of the present disclosure.

### DETAILED DESCRIPTION

Embodiments of the present disclosure provide an interactive digital camera for live crop editing and recording of video streams. According to the present disclosure, a camera device is provided. In some embodiments, the camera device provides seamless live video streaming to a network cloud infrastructure. In one embodiment, the camera device can switch an output video field of view of the camera to stream only a cropped area onto the cloud while a full field of view is published to a display. For instance, the camera is capable of capturing a single input video image and producing two streams in which a first stream (e.g., without a crop view) is for use by an operator and the second stream is with a cropped view for viewers. Thus, the camera provides for a live multiple-camera production environment from a single input video stream.

The present disclosure relates to a device for performing the operations herein. In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure. In one embodiment, the device may utilize an application associated with the mobile phone, such as a phone app. In other embodiments, the device is a phone app controlled by another phone app. Still further, the device and a controller for the device may be in a single phone app. In some embodiments, a user may have to install the application and/or select a service in order to obtain the benefits of the techniques described herein.

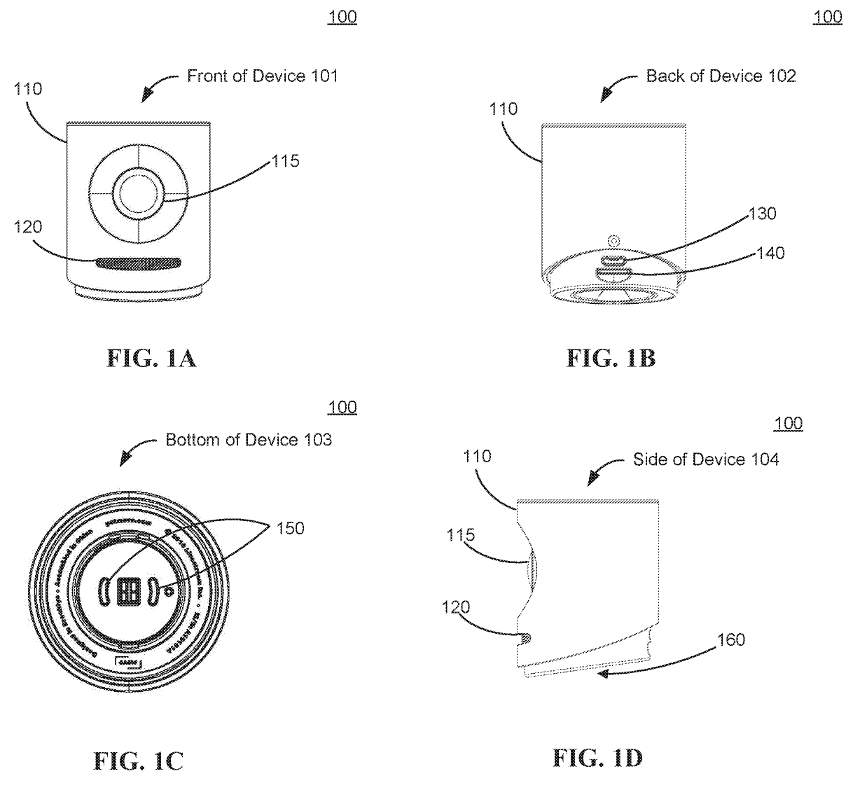

FIGS. 1A-1D are perspective views of an exemplary camera device 100 in accordance with embodiments of the present disclosure. Although components of the camera device 100 are shown in a particular arrangement, it should be appreciated that the components may be arranged and/or disposed in and/or on different parts of the camera 100 than what is shown. In some embodiments, the camera device 100 can be wirelessly coupled to a mobile device (not shown), such as a mobile phone, via a network connection. (e.g., Wifi/Bluetooth). In some embodiment, the camera 100 can generate a Wifi hotspot in which the mobile device can sign onto for communication of video stream data from the camera 100. The mobile device may be used to control aspects of the camera 100 as well as for displaying, editing and recording live the video streams captured by the camera.

FIG. 1A depicts a front view 101 of the camera device 100. In one embodiment, the camera 100 includes a body 110 having a certain shape (e.g., cylindrical). The body 110 is housing sound and imaging components that include an image capturing component 115 (e.g., camera lens) to capture an image in a viewing direction of the camera device 100, a microphone and/or speaker component 120 as well as other components, such as internal hardware imaging and audio circuitry disposed therein. In some embodiments, the camera 100 may include a replaceable cover that may be disposed over the body 110 portion of the camera 100.

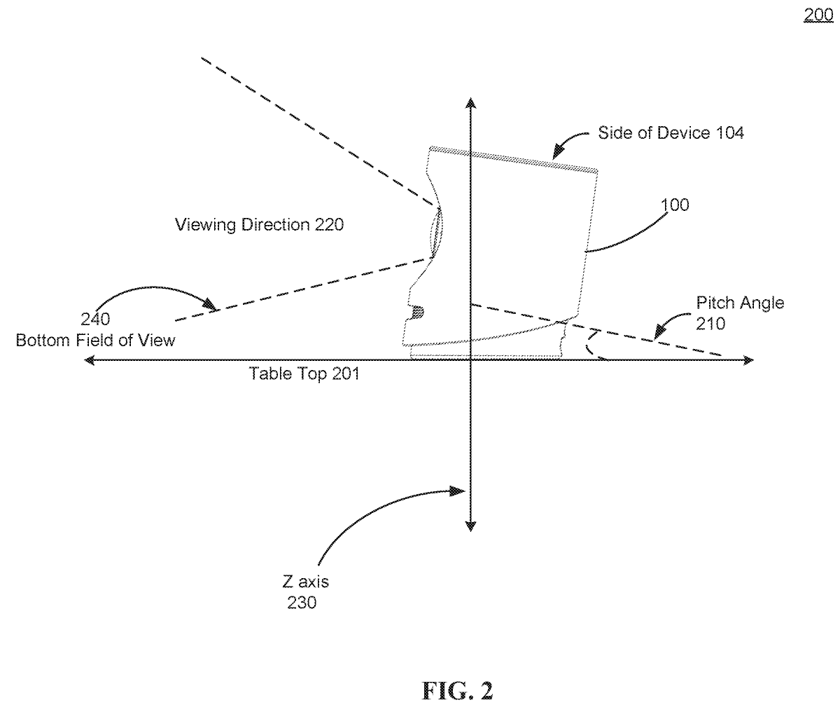

FIG. 1B depicts a back view 102 of the device 100. As shown in FIG. 2B, the camera device 100 may further comprise other components that include, but not limited to, an interface port 130 for connecting with a Universal Serial Bus (USB) capable device and a memory slot 140 for receiving an external memory card, such as a type of SD memory card. In some embodiments, video stream data captured by the camera may be stored in all or in part of a memory card disposed in the memory slot 140 or in an internal memory (not shown).

FIG. 1C depicts a bottom view 103 of the camera device 100. As shown in FIG. 1C, the camera 100 may further include one or more power ports 150. The one or more power ports 150 may be used to recharge an internal battery (not shown) of the camera 100. For example, the power ports 150 may receive a certain type of charging cable (not shown) coupled to a power supply, such as an electrical outlet.

FIG. 1D depicts a side view 104 of the camera device 100. As shown in FIG. 1D, the camera includes a supporting base portion 160. In some embodiments, the supporting base 160 of the camera 100 is angled at a certain degree. For example, the supporting base 160 is arranged so that it is at a relative angle with respect to the body 110 of the camera 100 rather than being substantially horizontal. This so that when the camera 100 is place on a substantially planar (e.g., flat) surface, such as table top, the camera 100 may tilt the viewing direction of the camera 100 at a moderate angle upward and towards a subject of interest and away from the table and shelf surface. An advantage of angling the supporting base 160 of the camera 100 in this manner is that the field of view of the camera 100 may be improved because the field of view is expanded based on the incline of the tilt. Further, this allows the field of view of the camera to be considerably unencumbered by any flat surface that the camera is placed upon.

FIG. 2 is a side view 104 of the camera device 100 in accordance with one embodiment of the present disclosure. In this example, the camera 100 is shown resting on a table top 201. The camera's orientation can be expressed in three dimensions, such as X, Y and Z axes, where the X and Y axis represents a horizontal and vertical position respectively with respect to a surface of the table top 201, and the Z axis represents a position of the camera 100 relative to a plane perpendicular to the direction of gravity, e.g., ground. It shall be assumed for ease of understanding and not limitation that the camera angle is fixed relative to the orientation of the camera 100. As shown, FIG. 2 illustrates a potential pitch angle 210 of the camera 100 (as seen looking towards the left side of the camera) relative to the table top 201.

Collectively, the pitch angle 210 and the X, Y and Z axis positions define the camera orientation. Hence, a viewing direction 220 (e.g., of which the camera points) is relative to the camera orientation. By pointing a lens of the camera 100 in a desired direction, the camera 100 is able to capture images of a subject of interest. As shown in FIG. 2, the viewing direction 220 is pitched slightly upward with respect to the surface of the table top 201. In some embodiments, the pitch in the viewing direction 220 is relative to the pitch angle of the camera 100. This is especially useful in that the camera 100 may be able to capture more of the subject of interest without a portion of the table top 201 cutting off part of the captured image. For example, the pitched camera base allows the bottom field of view 240 in the viewing direction 200 of the camera 200 to extend further across the table 201 than in a camera without the pitched camera base. The pitched camera base is also particularly useful in that the camera 100 can be positioned further back on the table top 201 from the subject of interest, which can help prevent the camera 100 from falling off, for example, in response to the table 201 being accidentally bumped.

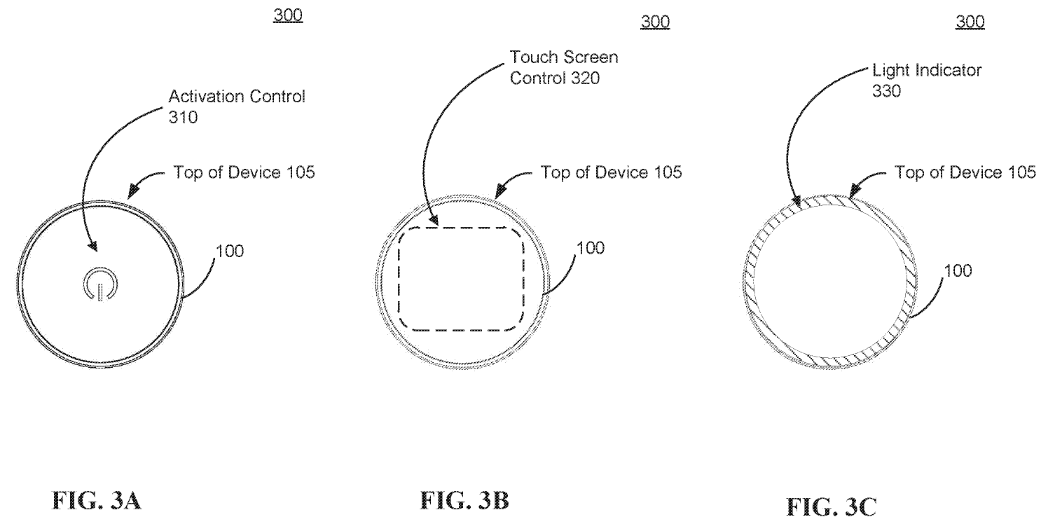

FIGS. 3A-3C are example overhead views 300 of the camera 100 in accordance with embodiments of the present disclosure. In some embodiments, various components of the camera 100 may be disposed on the top of camera device 105. Some examples of these types of components are discussed below.

As shown in FIG. 3A, one embodiment of the camera 100 may include an activation control 310. In some embodiments, the activation control 310 may be disposed on the top of the device 105. In an alternative embodiment, the activation control 310 can be disposed on other parts of the camera 100, such as on a side of the camera 100. The activation control 310 may include a control button that when activated may power on/off the camera 100. For example, the control button when touched or depressed may activate the activation control 310. Other type of activation control 310 known in the arts may also be used.

As shown in FIG. 3B, another embodiment of the camera 100 may include a touch screen control 320. In some embodiments, the touch screen control 320 may be disposed on the top of the device 105. In an alternative embodiment, the touch screen control 320 can be disposed on other parts of the camera 100, such as on a side of the camera 100. The touch screen control 320 may include a display that can detect the touch of user. In some embodiments, the touch screen control 320 can be used to control the output video field of view the camera 100 to stream only a cropped area on the cloud. As noted above, the camera is capable of capturing a single video image and producing dual ultra-high definition encoded streams. In other embodiments, the touch screen control 320 may be used to send cropping instructions associated with a region of interest in the field of view the camera 100, switch between the dual encoded streams or control a display of each stream onto an output display or cloud network.

As shown in FIG. 3C, yet another embodiment of the camera 100 may include a light indicator 330. In some embodiments, the light indicator 330 may be disposed on the top of the device 105. In an alternative embodiment, the light indicator 330 can be disposed on other parts of the camera 100, such as on a side of the camera 100. Although in this example the light indicator 330 is shown in a ring configuration disposed along the top of the device 105, other configurations of the light indicator 330 are possible.

The light indicator 330 may be used as a type of status indicator for the camera 100 even though other uses are possible. In some embodiments, the light indicator 330 can be used to indicate that the camera is on or off, battery status and whether the camera is recording, paused or stop. For example, the light indicator may change color depending on its current status. In other embodiments, a portion of the light indicator may indicate which direction the camera is currently cropping. An advantage of having the light indicator on top of the camera 100 is that it may standout more particularly from far away.

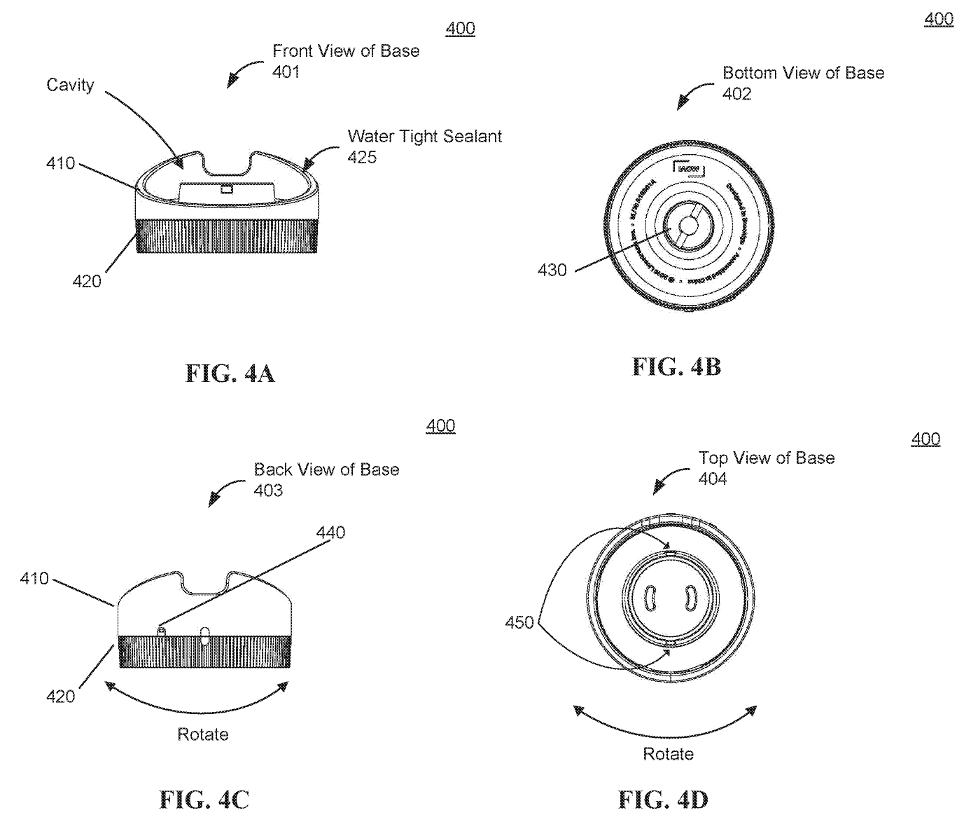

FIGS. 4A-4D are perspective views of an exemplary base unit 400 in accordance with embodiments of the present disclosure. Although components of the base unit 400 are shown in a particular arrangement, it should be appreciated that the components may be arranged and/or disposed on different parts of the base unit 400 than what is shown. In some embodiments, the base unit 400 may be elongated and include additional I/O ports that include, amongst other things, and extra power supply for powering the camera as well as operate as a housing for additional communication memory components, and motion control devices.

FIG. 4A depicts a front view 401 of the base unit 400. In some embodiments, the base unit 400 includes a first portion 410 and a second portion 420. The base unit 400 is configured to be coupled to the camera 100. In one embodiment, the first portion 410 may receive a portion of the camera 100 through a cavity disposed therein. When the camera 100 is placed within the cavity, a water tight seal may be created between the base unit 400 and camera 100. For example, the base unit 400 includes a sealant 425 to stop fluids from entering into the space between the joined base unit 400 and camera 100.

The sealant 425 may be made of a particular type of material that is rated to block the passage of certain kinds of fluids (e.g., rainwater) of a particular amount. This sealant 425 is particular useful when the camera 100 is used outside, such as when it is placed on a tripod stand outdoors. In some embodiments, the base unit 400 may include a port for received a mount point of the stand. In FIG. 4B, a bottom view 401 of the base unit 400 is shown. As shown, the port 430 may be disposed at a bottom of the base unit 400 and is configured to receive various kinds of standard and non-standard stands.

FIG. 4C depicts a back view 401 of the base unit 400. In this example, a locking switch 440 is shown disposed on the back of the base unit 400. The locking switch 440 is used to prevent and/or allow the second portion 420 of the base unit 400 to move or twist in a certain direction with respect to the first portion 410. For example, the locking switch 440 may be a toggle switch that can be engaged and disengaged, for example, by moving the switch up and down. In some embodiments, if the toggle switch is engaged, the second portion 420 of the base unit 400 may be prevented from moving with respect to the first portion 410. If the toggle switch is disengaged, then the second portion 420 of the base unit 400 may move or twist freely with respect to the first portion 410.

In some embodiments, the first portion 410 and the second portion 420 of the base unit 400 may be rotatably coupled together. This allows one portion of the base unit 400 to move with respect to the other portion. For example, a user may hold the first portion 410 and rotate or twist the second portion 420 in a horizontal direction with respect to the first portion 410. In some embodiment, the two portions are rotated in order to lock the camera 100 and base unit 400 together. This is further explained with respect to FIG. 4D.

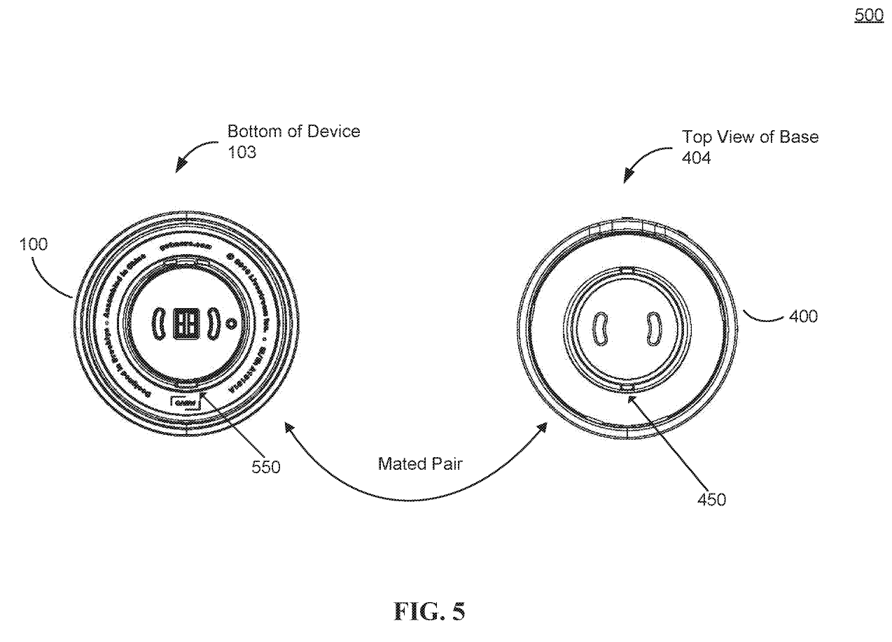

FIG. 4D depicts a top view 401 of the base unit 400. As shown, the base unit includes one or more posts 450. The posts 450 are used to secure the base unit 400 to the camera 100. For example, each of the posts 450 may mate with a corresponding port in the camera 100. As shown FIG. 5, each post 450 of the base unit 400 is configured to mate with a corresponding port 550 disposed at a base of the camera 100. When the second portion 420 of the base unit 400 is rotated in a certain direction the post 450 is locked into the port 550.

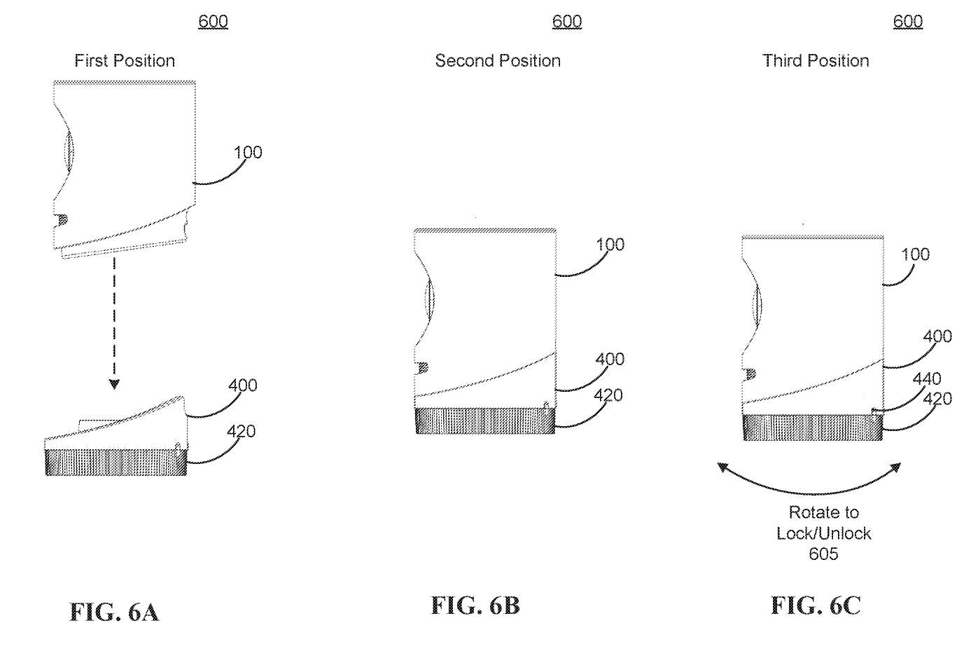

FIGS. 6A-6C are example side views of the camera device 100 with the base unit 400 in accordance with one embodiment of the present disclosure. In these examples, steps for securing the camera device 100 to base unit 400 are shown.

With regards to FIG. 6A, the camera device 100 is shown at a first position with respect to the base unit 400. For example, the camera device 100 may be positioned so that a base of the camera 100 is oriented towards a cavity in the base unit 400. At this point, the locking switch 440 may be in an open position so that the first and second portions of the base unit 400 may be able to freely rotate. This initial placement of the locking switch 440 may help when the camera device 100 is mated with the base unit 400 by helping to ensure that the parts line up correctly.

Turning to FIG. 6B, the camera device 100 is shown at a second position with respect to the base unit 400. As shown, the camera device 100 has been moved towards or placed onto the base unit 400. In one embodiment, the camera device 100 may be positioned so that magnets attached to a base on the camera device 100 can make contact with a metal portion of the base unit 400 or vice versa. The magnets may be used to temporarily hold the camera device 100 to the base unit 400. An advantage of using the magnets is that they may help in aligning the base of the camera device 100 to the cavity in the base unit 400.

In FIG. 6C, the camera device 100 is shown at a third position with respect to the base unit 400. As shown, the camera device 100 has been moved toward or placed onto the base unit 400. A movement of the second portion of the base unit 400 may then securely couple the camera 100 and the base unit 400 tightly together. For example, the second portion of the base unit 400 may be rotated in a certain direction. This may allow the camera 100 and the base unit 400 to be firmly clamped to one another and help prevent fluids (e.g., rain water) from entering between therein. Thereafter, the locking switch 440 can be engaged so that the base unit 400 does not move out of place with respect to the camera 100. Once the camera 100 is secured to the base unit 400, the base unit 400 may be attached to a stand, such as a standard camera tripod.

To detach the camera device 100 from the base unit 400, the steps described above may be executed in reverse order. For example, the locking switch 440 may be disengaged and the second portion of the base unit 400 may be rotated in an opposite direction with respect to the camera device 100. Thereupon, the camera device 100 can be detached from the base unit 400.

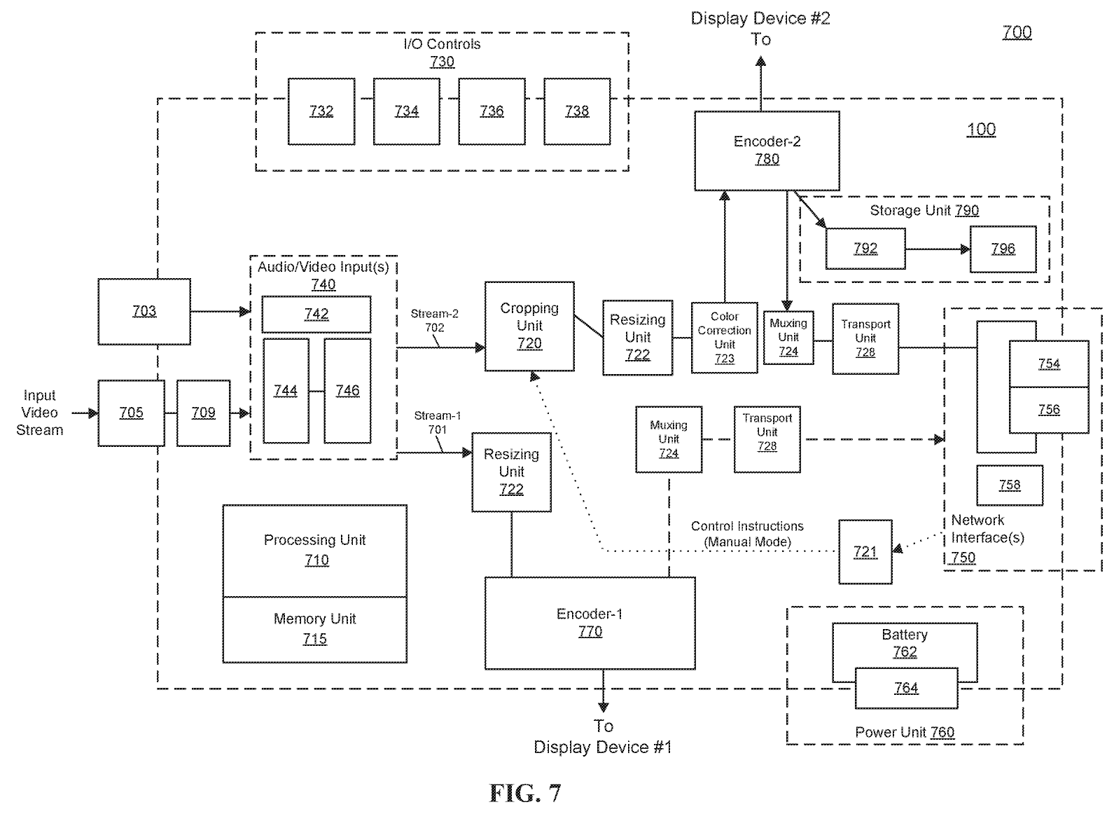

FIG. 7 illustrates a block diagram 700 of the camera device 100 in accordance with embodiments of the present disclosure. In some embodiments, the functionality of camera device 100 can exist in a fewer or greater number of modules than what is shown. The modules may be operable in conjunction with camera device 100 from which it may receive and provide relevant information regarding the input video stream. In some implementations, the camera device 100 includes processing unit 110, such as a processor, coupled to a memory unit 715 to store video streams, several I/O controls 730 that may include configuration and reset buttons 732, 734, 736 and 738, audio/video input controls 740 that may include an audio mixer 742 and video processing units 744 and 746 to process raw audio/video data receive from a connected microphone 703 and fixed lens 705 and video sensor 709, one or more network interfaces 750 for a wireless connection port 754, wired connection port 756 or Bluetooth connection 758 to a network, a power unit 760 coupled to a rechargeable battery 762 and a power source 764, a first and second encoder 770 and 780 and a storage unit 790 that include a video muxing unit 792 for storing videos on an external memory card 796.

Referring to FIG. 7, the camera 100 may be comprised of a raw video processing platform that may convert an input video stream into dual video streams (e.g., stream copy #1 701 and stream copy #2 702). In one embodiment, the raw video processing platform may be comprised of one more modules configured to process the video streams and transport the processed data to multiple display devices. For example, the camera 100 may include one or more resizing units 722 to resize each video stream to determined format (e.g., 1080p), a color correction unit 723, and muxing and transport units 724 and 728 for converting the video steams to a network transport data format. In some implementations, the camera 100 may include a first encoder (e.g., encoder #1 770) to encode video streams for presentation at a first display device and a second encoder (e.g., encoder #2 780 to encode video streams for presentation to at a second display device.

In some embodiments, the first video stream 701 depicts a full field of view of an image associated with the input video stream captured by the camera 100 and sent to encoder-1 770 and the second video stream 702 depicts a cropped view presentation of the full field of view sent to encoder-1 780. For example, the camera device 100 may include a cropping unit 720 that may receive cropping instructions from the mobile device in communication with the camera via control panel 721. For example, the cropping unit 720 may receive the crop instructions from an interface installed at the mobile device that allows a user to select a certain region of interest from the full field of view. These crop instructions may include, but not limited to, a pinch to zoom instruction, tap to cut instruction, drag to pan instruction, computer aided vision and audio fining and tracking instruction, live editing decisions instruction as well as optimization instruction for the full field of view in view of the selected region of interest. In some implementations, the camera 100 can switch an output video field of view for a particular output display device/network to stream only a cropped presentation of the input video stream. Those skilled in the art will appreciate that the raw video processing platform of camera 100 may be configured with more or less modules than shown in FIG. 7.

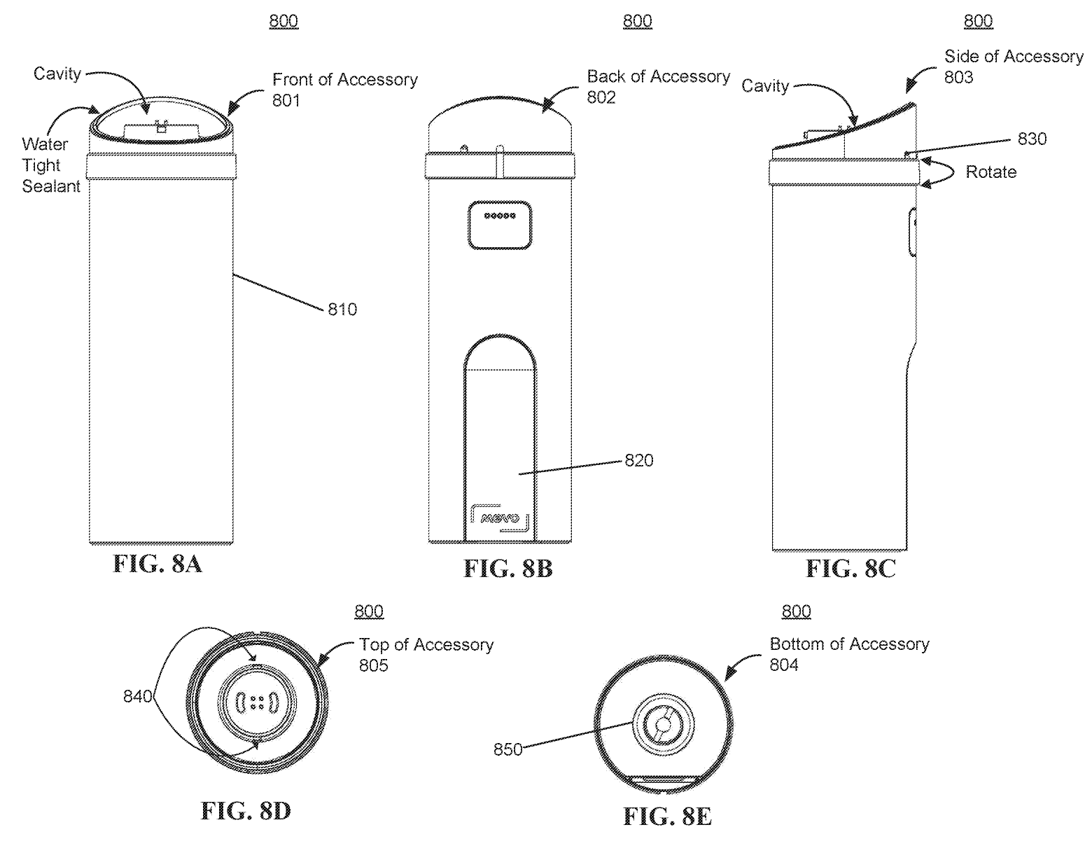

FIGS. 8A-8E are perspective views of an accessory device 800 for the camera device 100 in accordance with embodiments of the present disclosure. Although components of the accessory 800 are shown in a particular arrangement, it should be appreciated that the components may be arranged and/or disposed in and/or on different parts of the accessory 800 than what is shown.

FIG. 8A depicts a front view 801 of the accessory device 800. In one embodiment, the accessory 800 includes a body portion 810 having a certain shape (e.g., elongated cylindrical), although other shapes are possible. For example, the body portion 810 may include a slope or gripping portion for handling by a user. In some embodiments, the accessory 800 may be configured to be attached to the camera 100. For example, the body 810 of the accessory 800 may receive a portion of the camera 100 through a cavity disposed therein. When the camera 100 is placed within the cavity, a water tight seal is created between the accessory 800 and camera 100. For example, the accessory 800 includes a water tight sealant to stop certain fluids of a particular amount from entering into the space between the joined accessory 800 and camera 100.

FIG. 8B depicts a rear view 802 of the accessory device 800. In some embodiments, the accessory 800 may be used to house additional components for use with camera 100. As shown in FIG. 8B, the accessory 800 includes a component cover 820 covering an access area for accessing the additional camera components. Examples of some of additional types of components may include, but not limited to, an additional power component used as an extra battery supply for powering the camera 100 for a determined length of time, memory components for storing data, USB ports for coupling external components to the camera 100 as well as other types of components known in the arts that can be used with the camera 100.

FIG. 8C depicts a side view 803 of the accessory device 800. As noted above, the camera 100 can be attached to the accessory 800. To attach the camera 100 to the accessory 800, the camera 100 may be positioned so that a base of the camera 100 is oriented towards the cavity in the accessory 800. Then, the camera device 100 is moved towards or placed onto the cavity. In one embodiment, the camera device 100 may be positioned so that magnets attached to a base on the camera device 100 can make contact with a metal portion of the accessory 800 or vice versa. The magnets may be used to temporarily hold the camera device 100 to the accessory 800.

A portion of the accessory 800 is then rotated to securely couple the camera 100 and the accessory 800 tightly together. As shown in FIG. 8D, a top of the accessory device 800 includes one or more posts 840 that are used to secure the accessory 800 to the camera 100. For example, each of the posts 840 may mate with a corresponding port in the camera 100, which is then locked into place. With regards to FIG. 8C, a locking switch 830 may be engaged so that the accessory 800 does not move out of position with respect to the camera 100. For example, the locking switch 830 may include a toggle switch that can be engaged and disengaged, for example, by moving the switch up and down, to prevent or allow the portion of the accessory 800 to rotate out of position.

Once the camera 100 is secured to the accessory device 800, the accessory 800 may be attached to a stand, such as a standard camera tripod. In FIG. 8E, a bottom view 804 of the accessory 800 is depicted. As shown, the accessory 800 includes a port 850 that is configured to receive various kinds of standard and non-standard stands.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

What is claimed is:

1. A camera device comprising:
a body portion housing an image capturing component to capture an input video stream in a viewing direction of the camera device; and
a first encoder component and a second encoder component coupled to the image capturing component, the first encoder component to generate a first video stream based on the input video stream and the second encoder component to generate a second video stream based on the input video stream,
wherein the body portion comprises a first surface and a second surface opposite the first surface, and the second surface is arranged to pitch the body portion at a determined angle upward with respect to a substantially planar surface to support the camera device.

2. The camera device of claim 1, wherein the body portion is a cylindrical shape.

3. The camera device of claim 1, further comprising a replaceable cover disposed over the body portion.

4. The camera device of claim 1, further comprising a memory slot memory slot for receiving an external memory card to store the first video stream and the second video stream.

5. The camera device of claim 1, further comprising a touch screen control disposed on the first surface of the body portion.

6. The camera device of claim 5, wherein the touch screen control is adapted to receive a crop instruction associated with a region of interest in the first video stream.

7. The camera device of claim 6, wherein the touch screen control is adapted to switch an output video stream comprises from either the first video stream depicting a full field of view or the second video stream depicting a cropped view presentation of the full field of view.

8. The camera device of claim 1, further comprising a light indicator disposed on the body portion.

9. The camera device of claim 8, wherein the light indicator comprises a circular ring attached to the first surface of the body.

10. The camera device of claim 8, wherein the light indicator to indicate at least one of: an on or off status, battery status and a recording status of the camera device.

11. The camera device of claim 1, further comprising a base unit comprising one or more I/O port for use with the camera device, the base portion to mate with the second surface of the body portion.

12. The camera device of claim 11, wherein the base unit is elongated in shape.

13. The camera device of claim 11, wherein the base unit comprises a lock to lock the base unit to the second surface.

14. The camera device of claim 11, further comprising a water resistance seal disposed between the base unit and the second surface.

15. The camera device of claim 11, further comprising a port attached to the base unit, the port to receive a stand for supporting the camera device.

16. The camera device of claim 1, wherein the first video stream depicts a full field of view of an image associated with the input video stream and the second video stream depicts a cropped view presentation of the full field of view.

17. The camera device of claim 16, further comprising a cropping unit coupled to the second encoder, the cropping unit to receive a crop instruction associated with a region of interest in the input video stream.

18. The camera device of claim 17, wherein the crop instruction comprises at least one of: a pinch to zoom instruction, a tap to cut instruction or a drag to pan instruction.

19. The camera device of claim 18, further comprising correction unit coupled to the cropping unit, the correction unit to adjusting an exposure setting of the crop view presentation based on a selection of the region of interest.
